(19) United States
(12) Patent Application Publication
(10) Pub. No.: US 2007/0175533 A1
(43) Pub. Date: Aug. 2, 2007

(54) Method and layering for convoluted hose

(76) Inventors: Roy Howard Herron JR., Starr, SC (US); Stephen Jay Mountford, Abbeville, SC (US); Thomas Ronald Dove, Calhoun Falls, SC (US); Wei Lan, Greenwood, SC (US)

Correspondence Address: Thomas A. O'Rourke;Bodner & O'Rourke, 425 Broadhollow Road, Melville, NY, 11747, US

(21) Appl. No.: 11/108,631

(22) Filed: Sep. 8, 2004

Related U.S. Application Data
(60) Provisional application No. 60/501,043, filed on Sep. 9, 2003.

(51) Int. Cl. F16L 11/00

(52) U.S. Cl. 138/122; 138/137

(57) ABSTRACT

An improved flexible hose is described. The flexible hose may have a helical wire core with at least one thermoplastic layer over the core forming the hose. The helical wire forms a plurality of peaks separated by adjacent valleys on the hose. The peaks have a protective strip over the peaks that may extending along the peaks on the hose. The protective strip covers substantially only the peaks while leaving a major portion of the valleys uncovered by the strip.

This is a conversion of U.S. application Ser. No. 60/501,043 filed Sep. 9, 2003, the disclosures of which are incorporated herein by reference.

### BACKGROUND OF THE INVENTION

An automobile's heating and cooling systems are intricate arrays of mechanical and chemical components that are used to control the temperature of the engine and the cabin of the car. Most of the energy in gasoline is converted into heat by a running engine. The job of the car's cooling system is to dissipate and displace that heat to prevent engine seizure due to overheating. The cooling system does this by transferring the engine heat to the air. Additionally, the cooling system allows the engine to heat up quickly in cold temperatures, so that the engine can obtain its optimal running temperature more rapidly. The cooling system will attempt to maintain the engine at this temperature during operation.

There are two types of cooling systems used in most automobiles. The first is a liquid cooling mechanism, which involves circulating a fluid through pipes and passageways in the engine. As the liquid passes through the engine, heat transfer will occur, as the much cooler liquid will absorb heat from the hotter engine. When the liquid leaves the engine, it will have absorbed an inordinate amount of heat. The liquid is then passed through a heat exchanger, typically a radiator, and released into the air blowing through the radiator. In most cars, the radiator is located towards the front of the engine block, behind a grill on the front of the car. When the car is moving, air is passing through the grill and the radiator. The liquid releases the heat into this moving air, thereby cooling the liquid. When the liquid has been cooled, it will be ready to be passed through the engine again.

A second type of cooling system involves a simple air cooling dynamic. Without a circulating fluid, the engine block is covered in aluminum fins. The aluminum fins have a high thermal conductivity and transfer heat away from the engine cylinders. A fan rotating over the fins forces the fins to transfer heat to the blown air. This type of cooling system is typically seen in earlier model cars.

The heating system in a car is composed of a small radiator and functions basically as a secondary cooling system. A heater core located under the dashboard of the vehicle is typically a small radiator. The heater core draws hot coolant from the cylinder head on the engine and returns it to the water pump. A heater fan blows air through the radiator and into the passenger compartment of the vehicle. The air blowing through the radiator is relatively cool and becomes heated by the hot coolant in the radiator. The amount of hot air being blown into the passenger compartment is regulated by the heater fan, which is operated by controls on the dashboard.

The heating system includes the defroster, or defogger or demister, on a vehicle. The demister is a heater that removes mist from the windshields and windows of a car. The demister removes mist by carrying heating, ventilation and air-conditioning (HVAC) from the heating and cooling systems to the outboard vents, typically located on the dashboard of the car. Hoses are used to transport the heated or cooled air to the outboard vents. Typically, a car has one or two demister hoses, which are usually located beneath the dashboard of the car. In this location, the hoses are susceptible to rattling, and possibly dislodging from their connection points, because they may vibrate against other internal parts in the same location. The demister hoses of the prior art are usually made from a single ply of a thermoplastic material such as PVC around a PVC coated spring steel helix.

To prevent rattling and dislodging of the demister hoses, the prior art has contemplated placing a cylindrical, tight-fit sleeve over the hose. Often, the sleeve is composed of foam, which can absorb the shock of, and allow for quiet contact with internal parts. However, there are certain disadvantages that are inherent with the use of a sleeve to cover the entire outer surface of the length of the hose. First, the sleeve is a separate component that must be installed. Thus, in manufacture of a vehicle, a demister hose must have a sleeve placed on it, before being installed in the car. When pulling the sleeve over the hose, the sleeve is susceptible to tearing, stretching or the frictional wear associated with pulling the foam sleeve over a plastic hose with a convoluted surface. Additionally, the convoluted portion of the hose is the only portion that will come into contact with internal parts. The convolutes are typically so close together that the part of hose between them will never touch the internal parts. Hence, there is a significant material waste incurred with using a sleeve to cover the entire hose.

### OBJECTS OF THE INVENTION

It is an object of the present invention to provide an improved convoluted hose for demisters and the like that eliminates the need for a protective sleeve over the demister hose.

It is an object of the present invention to provide a convoluted hose for demisting applications and the like where the peaks on the convoluted hose are reinforced so that a sleeve is not required over the hose in automotive applications and the like.

It is a still further object of the invention to provide an improved convoluted hose having a protective strip over a thermoplastic outer material that covers a helical spring that is resistant to abrasion.

It is another object of the invention to provide a hose where the peaks of a convoluted hose are protected from tearing.

It is an object of the present invention to provide a layering for a convoluted hose for use with a demister in a car, van, truck, or any other transportation vehicle.

It is an object of the present invention to provide a protective layering for a convoluted hose which protects peaks and not the valleys in a convoluted hose.

It is an object of the present invention to provide a layering for a convoluted hose which reduces the amount of material used as compared to the prior art combination of a convoluted hose and a demister hose sleeve.

It is an object of the present invention to provide a layering for a convoluted hose which reduces hose manufacturing costs.

It is an object of the present invention to provide a layering for a convoluted hose which protects the hose from contact with its objects in its environment.

It is an object of the present invention to provide a layering for a convoluted hose which protects objects in the hose's environment with a shock absorbing material.

### SUMMARY OF THE INVENTION

The present invention is directed to a unique, improved flexible hose for use in automotive and other applications. The hose is preferably made from a spring or helical metal or plastic wire that may be covered with a thermoplastic material. The thermoplastic material forms a sleeve over the helical wire to form a flexible hose. The surface of the metal or plastic spring can, if desired, be covered with a thermoplastic material. This plastic wire or the thermoplastic material over the helical member may be fused to the inner surface of the hose of the sleeve during extrusion of the sleeve over the helical member or secured by means of an adhesive. The sleeve of the hose may be made from a single layer of material or may have one or more additional layers as desired. In a preferred embodiment, the hose may have a sleeve of a thermoplastic polyolefin around a helical wire. The wire may be a single wire or a plurality of wires joined together.

The convoluted hose of the present invention has what can be termed peaks and valleys. Alternatively, the hose may have a series of convex portions each convex portion being separated by a respective concave portion. The peaks are caused by the presence of the helical wire or spring. The valleys are the spaces between the portions of the helical springs. In the preferred embodiment, a strip typically made from a protective material is placed preferably only over the peak portion on the hose of the present invention.

The present invention has particular application for a convoluted hose for use in automotive applications including but not limited to use with a demister and in other non-automotive applications where protection of the peaks of the hose is desired. The present invention eliminates the labor and material waste associated with the prior art sleeve. The present invention may also be used on other types of hoses such as a corrugated hose, and as such, the term corrugated can be substituted for the term convoluted in the disclosure.

Wire reinforced hose of the type that can be used in the present invention may be made by a number of methods. One method is taught in U.S. Pat. No. 3,271,064. The disclosures of which are incorporated herein by reference.

Demister hoses are typically convoluted hoses composed of a thermoplastic material or a rubber or blends thereof. They must be able to withstand relatively high temperatures of heater systems, and be flexible enough to bend in cramped areas such as around internal parts under the dashboard of a car without tearing or puncturing. Usually, the demister hoses are composed of a length of cylindrical hose, with a convoluted outer surface formed by a helical member such as a wire. The convolutes on the outer surface of the hose are usually disposed at a certain distance usually constant across the length of the hose depending on the shape and arrangement of the spring or helical member on which the hose is formed. The other factor that may affect the distance between the peaks is the need to maintain a favorable amount of surface area to dissipate heat, while maintaining a flexible nature of the hose. A convoluted surface is generally shown in U.S. Pat. No. 6,142,188 to Schaerfl et al. The convoluted surface shown in Schaerfl et al. '188 is that used in the prior art. With the prior art hose a foam sleeve must typically be pulled over that surface to prevent rattling and dislodging of the hose in many applications such as in use as a demister hose.

The present invention is directed to a protective strip of a material over typically only the peak portions of a convoluted hose. In one embodiment there is a layer or strip which may be disposed over a portion of a convoluted hose. The protective strip can be manufactured from a foamed material, or a soft rubber or plastic suitable to protect the peak portion of the hose from contact with internal parts under the dashboard of an automobile. Additionally, the substance that the protective strip is made from should absorb the shock of contact with internal parts, thereby not dissipating any energy as noise, in the form of rattling. Preferably, the protective strip of the present invention is disposed only over a portion of the convolute of the hose.

The peak of a typical convolute on the hose can be described as having a first lower transition point, a upper sloping portion, a first upper transition point, a crest, a second upper transition point, a downward sloping portion, a second lower transition point and a base. The present invention contemplates several embodiments. In addition, the position of the protective strip can vary over the convolute of the hose depending on the particular application. In one embodiment, the protective strip can be run along the outer surface of the entire hose, including over every convolute. In this embodiment, the protective sheet may act as a film or protective covering that covers the entire length of the hose along its outer surface including the peaks and valleys of the hose. In another preferred embodiment, the protective covering portion runs from a first lower transition point over the convolute to a second lower transition point and from one end of the hose to the other. In a further embodiment, the protective covering portion may run from a region on the upper sloping portion to a region on the downward sloping portion as in the case of the other embodiments, the strip may run from one end of the hose to the other. In yet a further embodiment, the layering may run from a first upper transition point to a second upper transition point and likewise from one end of the hose to the other. In still yet a further embodiment, the layering may run simply over the crest of the convolute. It is understood that the layering of the present invention may begin at any point on a convolute and run to any point on the opposite side of the same convolute. Additionally, one or more portions of the hose may have convolutes that have protective coatings or layers with different orientations than other convolutes on the hose.

The orientations of the protective strip described above will prevent damage to a hose in many applications. The present invention will also prevent rattling and harmful contacts between demister hoses and internal parts under the dashboard of a car caused by contact between portions of the automobile and the outer surface of the convoluted portion. The method of disposing the layering in the manner described above will save a significant amount of material, that would otherwise be wasted between convolutes. Additionally, as the protective strip can be disposed over the convolutes during manufacture, the necessity of sleeve of the prior art will be greatly diminished.

### BRIEF DESCRIPTION OF THE DRAWINGS

FIG. 1 is a perspective view of the present invention alongside the prior art.

FIG. 2 is an enlarged view of the layering of the present invention.

FIG. 3 is a side view of a hose with convolutes utilizing the layering of the present invention.

FIG. 4 is a cross-sectional view of the hose of FIG. 3.

FIG. 5 is an enlarged view of a representative single convolute.

FIG. 6 is a side view of an alternate embodiment of the hose of the present invention.

FIG. 7 is an end view of the hose of FIG. 6.

FIG. 8 is a section of the hose taken along A-A of FIG. 7.

### DETAILED DESCRIPTION OF THE DRAWINGS

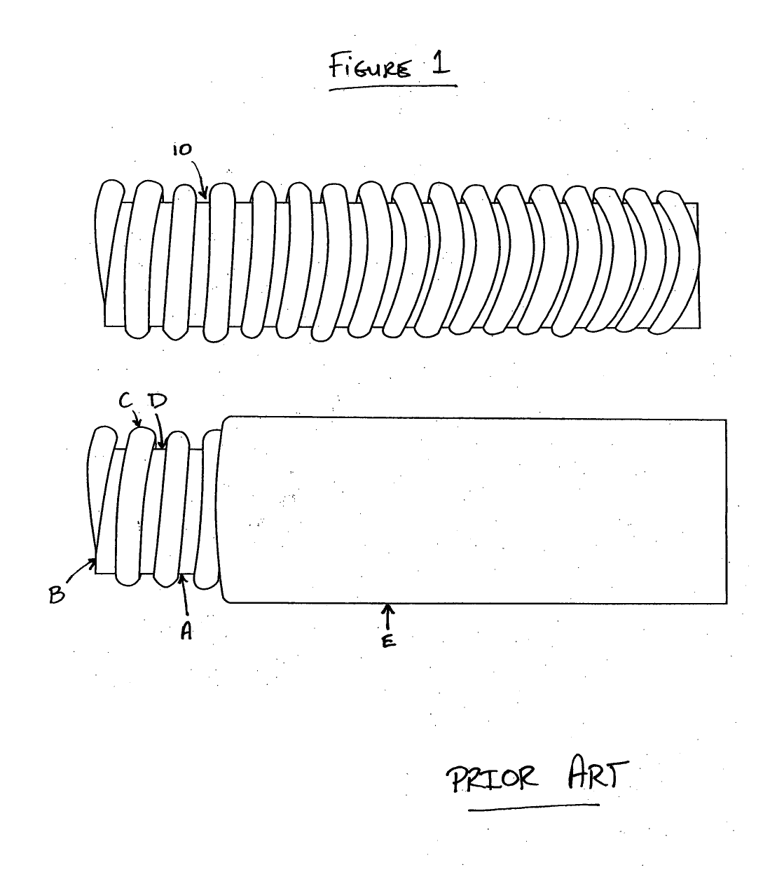

As seen in FIG. 1, there is depicted a hose made in accordance with the present invention. In one embodiment, the hose of the present invention is directed toward a hose used as a demister hose primarily under the dashboard of a car. The teachings of the present invention have applicability on hoses used in other applications as well. The hose of the present invention is generally seen at 10. Alongside the present invention of FIG. 1 is a representative prior art hose shown generally at A. The prior art hose is shown with a flexible outer covering or sleeve B with a plurality convolutes C along the length of hose. There is a valley or lower portion D between each of the convolutes. The prior art hose has a flexible covering B that is typically relatively thin and there is a great risk that manipulation of the hose to position it in, for example, the car under the dashboard can cause punctures, rips, tears, abrasions, etc. Without a covering, the hose would contact and collide with internal parts under the dashboard of a car. Hence, the prior art hoses in many applications use a sleeve E, which is fit over the entire length of the hose. The sleeve is generally cylindrical and typically has an inner surface that contacts the crest of each convolute. The sleeve is usually fit over the length of the hose before installation or replacement in a car.

In one embodiment of the present invention a series of portions of individual convolutes that are disposed on a typical hose are seen in FIG. 2. One of these convolutes 11 is shown in an enlarged form in FIG. 5. The convolute 11 includes a first base portion 12 which is part of the valley. First base portion 12 can be rounded or linear. First base portion 12 can lead into a first lower transition point 13 depending on the size of the hose and how flexible it is. First lower transition 13 point can be rounded, angled or squared, at a right angle, etc. Upper sloping portion 14 can follow first lower transition point 13. Upper sloping portion 14 can be disposed angled, or rounded, from first lower transition point 13, but is preferably a low degree angle off of the vertical axis, providing a more vertical than sloped orientation. Upper sloping portion 14 is joined to crest 15 by first upper transition point 16. First upper transition 16 point may be rounded, squared or angled. Crest 15 may be flat or rounded. Crest 15 may also come to a point, or apex (not shown).

The other side of the convolute may preferably be symmetrical or a mirror image to the first side, or may have a different orientation. In a preferred embodiment, crest 15 leads to a second upper transition point 17 on a side of crest 15 opposite the first upper transition point 16. Second upper transition point 17 can be rounded, angled or squared. Following second upper transition point 17 can be a downward sloping portion 18. Downward sloping portion 18 may be disposed a similar angle as upper sloping portion 14, to provide a symmetrical side to upper sloping portion 14. Downward sloping portion 18 may be rounded or linear. Downward sloping portion can lead into a second lower transition point 19. Second lower transition point 19 can be rounded, angled or squared. Second lower transition point 19 can lead into a second base portion 20, which will eventually lead to another convolute along the outer surface of the hose.

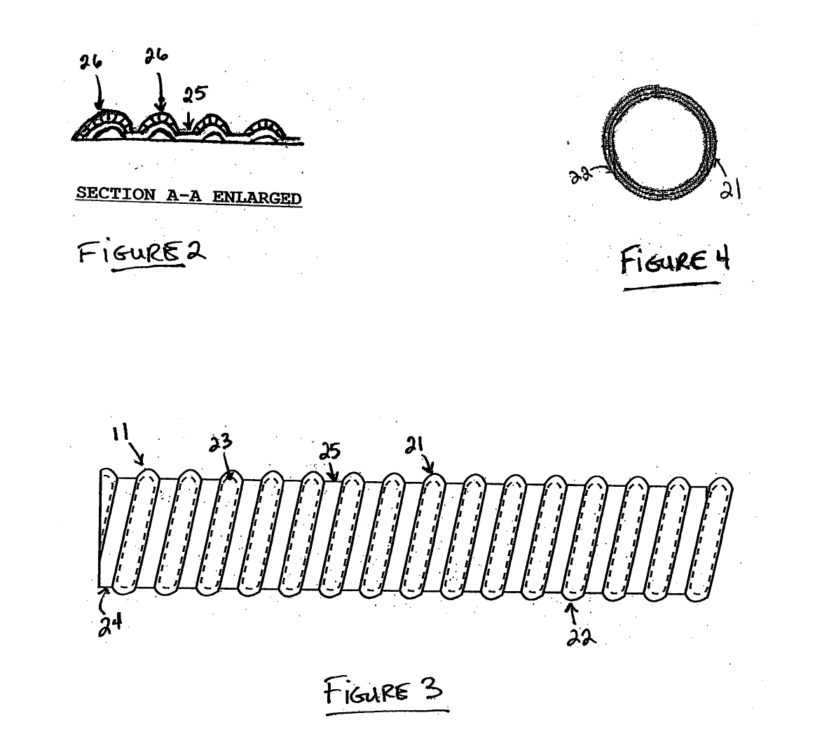

FIG. 2 and 3 depict how the protective sheet or layering 21 would be disposed on a convoluted hose 22. Layering or protective strip 21 can be a separate strip secured by an adhesive, it can be coextruded by an extruder with the extrusion of the outer surface of the hose, the protective strip can be extruded separately from the outer surface of the hose, etc. The layer 21 can also be made of a plastic, rubber or foam. In an alternative embodiment, the protective strip may be extruded over the hose, sprayed on it or applied by other suitable means. Convoluted hose 22 is seen with convolutes 23 disposed on the outer surface 24 of the hose 22. These convolutes are caused by the helical or spring member in the hose. The helical or spring member may be a plastic material or a metal member and where it is a metal is preferably coated with a thermoplastic layer which is secured to the underside of the hose by means of an adhesive or due to fusion during extrusion of the wire with the covering of the hose. Between each convolute is a base portion or valley 25. Due to the height of the convolutes above the outer surface 24 of the hose, the base portion 25 will likely never come into contact with any internal parts under the dashboard of a car. Even when the hose is bent back on itself, the convolutes are so close together that the base portion 25 is not usually exposed to the internal parts. Hence, the present invention shows layering 21 as being disposed only on convolutes 23. Manufacturing the hose 22 with the layering 21 disposed on the convolutes 23 will save significant material costs and labor costs. FIG. 5 shows a cross section of hose 22 in the area of the convolute.

FIG. 4 shows an end view of a cross section of the hose. As seen in FIG. 4 convolutes 23 and protective strip 21 are disposed on hose 22. As seen in FIG. 2, the protective layer 21 is shown as a series of individual layerings 26. Typically, the protective layer is a single strip laid down on the convolutes by extrusion or other means that extends over helical peaks formed by the helical wire or spring member. A preferred embodiment involves individual layerings disposed in some manner on each convolute of the hose and not on a major portion of the valleys 25, thereby further decreasing the material costs.

While FIG. 4 shows the protective layer 21 of the present invention disposed in a particular manner, it should be understood that the layering need only be disposed over the convolute in a manner suitable to protect the hose and internal parts from contact, and decrease rattling due to such contact. With reference to FIG. 2, the layer 21 of FIG. 4 may be disposed in any manner, so long as crest 15 is covered. For example, layer 21 may run from first base portion 12 over the convolute to second base portion 20. In a separate embodiment, layer 21 may run from a first lower transition point 13 over the convolute to a second lower transition point 19. In another embodiment, layer 21 may run from a position on upper sloping portion 14 over the convolute to a position on downward sloping portion 18. In a further embodiment, layer 21 may run from first upper transition point 16 over the convolute to second upper transition point 17. In yet a still further embodiment, layer 21 may simply be disposed on crest 15.

It should be understood that while symmetrical dispositions of the layer 21 have been described, further embodiments contemplate asymmetrical orientations of layer 21 over a convolute. For example, in one instance, layer 21 may run from first lower transition point 13 over the convolute to second upper transition point 17. This embodiment may be used for a hose that is disposed in a generally vertical manner. Hence, an orientation of layer 21 positioned more toward the top end of the hose may prevent against debris or elements falling on and harmfully contacting the hose. The layer 21 could absorb most of the impact.

The hose may be made of a suitable thermoplastic material such as an olefin resin, such as polyethylene or a polyvinyl chloride (PVC) or other thermoplastic material. The thermoplastic material is preferably extruded about a plastic support helix manufactured from polypropylene or rigid PVC. Alternatively, the thermoplastic material can be extruded about a helical metal wire. The metal wire may be provided with a thermoplastic covering. After a layer of thermoplastic is extruded over the helix or the spring a foamed material may be place over the thermoplastic or other material used as the primary material for the hose. The foamed material may be extruded over the primary material. In some instances an adhesive may be interposed between the body of the hose and the foamed material or the two may be fused together in the extrusion process.

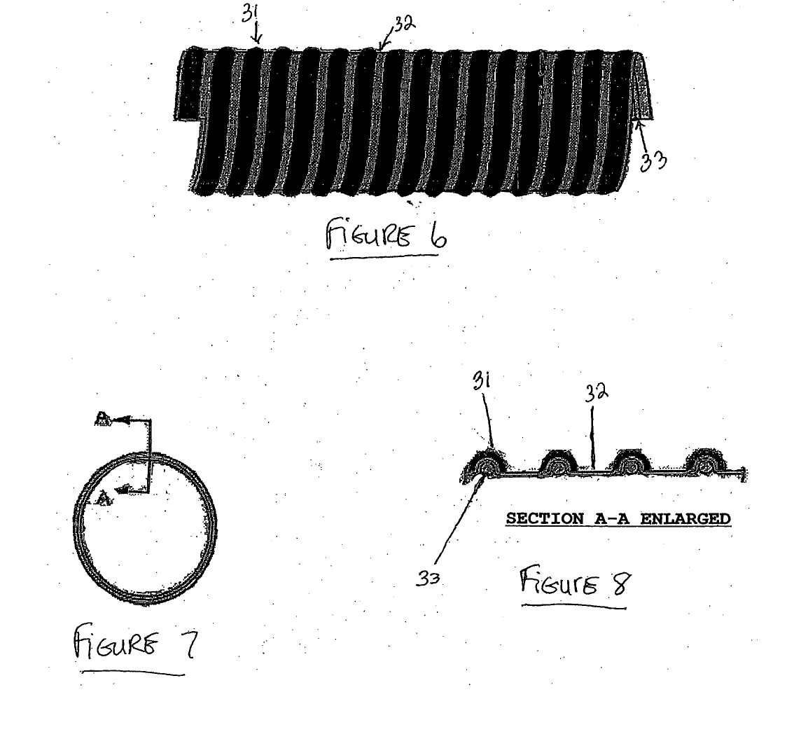

An alternative embodiment of the present invention is shown in FIGS. 6-8. In this embodiment, there is a sleeve 32 that extends over a helical member 33. Over the peak portions of the hose is a protective strip 31. This protective strip starts at a portion of the valley 34 adjacent to the first lower transition point 35. The protective strip may be continuous or have breaks therein depending on the application. In a preferred embodiment, the protective strip is a foamed thermoplastic elastomer (TPE) including but not limited to a foamed thermoplastic rubber. The sleeve of the hose 32 may be a thermoplastic polyolefin (TPO). The helical wire may be metal coated with a thermoplastic material or a plastic material such as polypropylene.

The TPR used is preferably a soft grade of Santoprene made by Advanced Elastomers. Many other TPE's and Olefin based polymers can work for the protective strip depending on the application. The TPE's can vary in hardness as well, although a foamed material is preferred for many applications. The hose cover 32 can be made from many TPE's or olefin based materials of varying degrees of hardness depending on the application. The helix is preferably polypropylene. There need not be a wire or core material used, but polypropylene coated wire could be used as well as any other polypropylene, olefin or TPE coating. Some preferred materials used can include for the foam strip material Advanced Elastomers “Santoprene 20168W228” TPR. The cover material can be advanced Elastomers “Vyram 9103-45” TPO. The helix material can be a Final 3467 Polypropylene Homopolymer

We claim:

1. An improved flexible hose, said flexible hose being comprised of a helical wire, said helical wire having disposed thereon at least one thermoplastic layer forming said hose, said helical wire forming a plurality of peaks separated by adjacent valleys, said peaks having thereon a protective strip, said protective strip extending along the peaks on the hose, said protective strip covering said peaks while leaving a major portion of said valleys uncovered by said strip.

2. A flexible hose construction comprising a corrugated hose made of at least one layer of a polymeric material, said polymeric layer having a plurality of outwardly convex projections with recessed portions therebetween, said outwardly convex projections being formed by a helically wound material under said polymeric material, said outwardly convex projection having a protective strip thereon, said recesses being substantially uncovered by said protective strip.

3. A method for assembling a hose onto a wire of a coil spring comprising the steps of:
a) providing a coil spring, said spring having a first end and a second end and a middle portion between said first and second ends;
b) placing said spring into an assembly fixture such that the first end of the wire of the spring is accessible, at least one winding being proximal to said first end of the wire of the spring;
c) extruding a thermoplastic polymer material over said spring to form a flexible hose, said flexible hose having a plurality of peaks separated by adjacent valleys, said peaks being formed by said coil spring;
d) applying a protective strip over the peaks of said flexible hose such that a substantial portion of each adjacent valley is uncovered by said strip.

4. The hose according to claim 1 wherein said peak has a first side and a second side, at least one side of said peak having adjacent thereto a first base portion which is part of a valley, said first base portion being adjacent to a first lower transition point on said peak, said first lower transition point being adjacent to an upper sloping portion on said peak opposite said lower transition point, said upper sloping portion being joined to a crest on said peak at a first upper transition point.

5. The hose according to claim 4 wherein the second side of said peak is a mirror image of the first side.

6. The hose according to claim 4 wherein said protective strip covers only each lower transition point, each upper sloping portion, each upper transition point and said crest of said peak.

7. The hose according to claim 6 wherein the protective strip covers only each upper sloping portion, each upper transition point and said crest of said peak.

8. The hose according to claim 7 wherein the protective strip covers only each upper transition point and said crest of said peak.

9. The hose according to claim 8 wherein the protective strip covers only said crest of said peak.

10. The hose according to claim 4 wherein said protective strip covers at least one lower transition point, at least one upper sloping portion, at least one upper transition point and said crest of said peak.

11. The hose according to claim 10 wherein the protective strip covers only at least one upper sloping portion, at least one upper transition point and said crest of said peak.

12. The hose according to claim 11 wherein the protective strip covers at least one upper transition point and said crest of said peak.

13. The hose according to claim 4 wherein said protective strip is extruded over said at least one thermoplastic layer.

14. The hose according to claim 4 wherein said protective strip is adhered to said at least one thermoplastic layer by means of an adhesive.

15. The hose according to claim 4 wherein said protective strip and said at least one thermoplastic layer are coextruded.
